(19) United States
(12) Patent Application Publication
(10) Pub. No.: US 2015/0121906 A1
(43) Pub. Date: May 7, 2015

(54) Systems and Methods for Converting Liquid Natural Gas to Compressed Natural Gas and to Low Pressure Natural Gas

(71) Applicant: Kenneth W. ANDERSON, Boerne, TX (US)

(72) Inventor: Kenneth W. Anderson, Boerne, TX (US)

(21) Appl. No.: 14/397,457

(22) PCT Filed: Apr. 25, 2013
(86) PCT No.: PCT/US13/38291

§ 371 Date: Oct. 27, 2014

Related U.S. Application Data
(60) Provisional application No. 61/637,908, filed on Apr. 25, 2012.

(51) Int. Cl. F17C 9/02

(52) U.S. Cl. CPC F17C 9/02; F17C 2221/033; F17C 2223/013; F17C 2223/031; F17C 2225/0153; F17C 2225/041; F17C 2227/0107
USPC 62/50.5

(57) ABSTRACT

A system for producing pressurized gas(es) from polar molecular liquids without the need to compress the gas(es) through outside Systems and methods for efficiently converting liquid natural gas (LNG) to compressed natural gas (CNG) and to low pressure natural gas (NG). The system efficiently modifies and controls the parameters of volume, pressure, and temperature in converting liquid natural gas (LNG) to compressed natural gas (CNG) and eventually to low pressure natural gas (NG) for the purpose of storing and dispensing the same for use in a variety of commercial, industrial, and in particular, residential applications.

### BACKGROUND OF THE INVENTION

1. Field of the Invention

The present invention relates generally to systems for efficiently converting liquid natural gas (LNG) to compressed natural gas (CNG), also known as pressurized natural gas (PNG), and further to low pressure natural gas (NG). The present invention relates more specifically to a system for efficiently modifying and controlling the parameters of volume, pressure, and temperature in converting liquid natural gas (LNG) to compressed natural gas (CNG) and eventually to low pressure natural gas (NG) for the purpose of storing and dispensing of each of the same for use in residential applications, as well as in a variety of commercial and industrial applications.

2. Description of the Related Art

Many efforts have been made in the past to efficiently store and convert liquid natural gas (LNG) to compressed natural gas (CNG) and then to dispense it as low pressure natural gas (NG). Most of these efforts suffer from significant losses and dependence on distributed heat energy during the processes of compressing and/or de-compressing the systems within which the quantities of natural gas, at various temperatures, pressures, and volumes, are maintained and transferred. Although the use of natural gas in industry, commercial manufacturing, and residential applications has and is continuing to increase, the ability to store, transport, and convert the low volume high quantity forms of natural gas has lagged behind the demand for natural gas in a variety of applications, particularly home fueling. Such storage, transportation, and conversion problems have become especially acute in the smaller residential applications associated with the use of natural gas. The ability to efficiently store, transport, and convert natural gas (typically in the form of CNG or LNG) has inhibited the ongoing growth of the natural gas industry for use in residential applications.

### SUMMARY OF THE INVENTION

The present invention provides a LNG to CNG conversion system with an optional NG supply and backup system, and an optional method for adding hydrogen gas to enhance the NG and CNG. The invention takes in LNG and by controlled warming converts it to vapor CNG, having the additional room to expand into but still contained within a small enough volume to result in an ideal fueling vapor pressure of CNG such as 3,000-3,600 psi. The warming conversion can occur as the result of thermal transfer using ambient temperature and lapse of time. The oval shape of the converter of one of the exemplary embodiments encourages movement of air and further enhances uniform thermal transfer.

Warming can also occur by using one of many types of heat sinks Natural gas within the system may be used for combustion to warm the thermal heat sink. Outside heat sources such as exhaust stacks or direct solar may also be used. The shape of the expansion chamber allows the thermal evolution of the heating of the LNG without resulting in dead end pockets of cold or hot gasses. The oval shape causes efficient heating and stage transference and enhanced thermal gas movement, as can be observed by thermal imaging. Optionally, if desired, the gas movement may be mechanically, electrically, or otherwise enhanced resulting in quicker and/or more consistent system-wide warming resulting in less thermal shock to equipment. The stack shape of the preferred embodiment is less expensive to construct and provides greater separation of the lower density gas production.

The function of the internal conduit in the present system is to isolate, in a practical cost efficient manner, the LNG, but not the CNG, from the outside pipe and allow the LNG to vaporize without touching the outside of the pipe, lessening metal stress that could occur from a localized cold spot on an otherwise non-stressed temperature vessel exterior, which could result in system life shortening metal fatigue or premature failure. To this end, a drip containment system and method shown as a partial pipe in the cross section to promote against such events occurring.

The system of the present invention will be used in a primary way to fuel natural gas (primarily methane) transportation vehicles such as cars, trucks, carts, lifts, cycles, etc. The present invention's CNG component can also be used as a feed stock for hydrogen production. The fuel made ready for use by the system of the present invention is superior to fuel supplied by non-LNG “natural gas” or mixed LNG sources and natural gas together, because it will be chemically more homogenous. Water is removed. Liquid distillates, such as butane, ethane, and propane, which can settle out of methane vapor (CH₄) in excess proportions are removed in the production of LNG when they freeze or separate, and as a result, these impurities are prevalent in the system's fuel production in known proportions. As opposed to other home fueling equipment, the fuel supplied by the system of the present invention is superior because it will not begin as residential NG chemically altered with sulphur or other chemicals, or contain water which can foul hydrogen fuel cells or leave unwanted deposits in internal combustion engines. The methane fuel supplied by the system of the present invention can easily be additionally enhanced by the addition of hydrogen gas to the expansion chamber to supplement those hydrocarbon molecules which have ability to take on additional hydrogen atoms, making it superior fuel compared to non-hydrogen additive systems, but being cleaner as well as providing more energy.

The system of the present invention will be used as transportation compressed natural gas (CNG) or pressurized natural gas (PNG) fueling station. The system of the present invention will further be used as a natural gas supply (NG) such as for a residence. The system of the present invention will be used as a reserve backup natural gas supply such as for a residence for purposes including emergency. The system of the present invention will be used as a supplemental natural gas supply point for a natural gas distribution system. The system of the present invention will be used as a point of sale of natural gas. The system of the present invention will be used for peak supply storage of natural gas.

This invention is scalable to allow dimensional changes which result in different beneficially targeted volumes and pressures for increased usefulness.

### BRIEF DESCRIPTION OF THE DRAWINGS

FIG. 1 is a partially schematic, partial cross-sectional, elevational view of the system of the present invention for converting LNG to CNG.

FIG. 2 is a partially schematic, partial cross-sectional, top plan view of the system of the present invention shown in FIG. 1.

FIG. 3 is a detailed cross-sectional view of the system of the present invention taken along cross-section lines A-A′ in FIG. 2.

FIGS. 4A-4D are detailed views of an LNG personal supply tank device of the present invention.

FIGS. 5A-5H are schematic block diagrams showing a variety of applications of the LNG to CNG to NG system and methods of the present invention.

FIGS. 6A-6G are partially schematic block diagrams showing an elevational view of an alternate preferred embodiment of the present invention for converting LNG to CNG and identify the progression of steps implemented to carry out the process of the invention.

FIG. 7 is a perspective view of a preferred embodiment of the phase change container structure of the present invention showing one implementation of a number of the structures shown generally in FIGS. 6A-6G.

### SUMMARY OF REFERENCED ELEMENTS

TABLE 1

| Ref. No. | Description |
|---|---|
| 301 | LNG fill portal for cryogenic like vessel. |
| 302 | Outer container for LNG. |
| 303 | Inner container for LNG approximate ratio being 1:2.4 by volume of expansion |
| | chamber shown scaled at 40 gallons made of a high nickel content steel or |
| | aluminum alloy. |
| 304 | Neck pipe, one way with valve connects LNG container to CNG expansion |
| | chamber inner pipe valve must be dual specification of LNG temperature and |
| | CNG pressure strength. |
| 305 | Inner oval pipe volume approximate ratio being 1:1 by volume to inner |
| | container made of a high nickel content steel or aluminum alloy. |
| 306 | Oval pressure vessel expansion chamber, preferably duplex stainless steel. |
| 307 | Transfer holes to vent vaporizing LNG transforming to CNG into expansion |
| | chamber in a uniform manner. |
| 308 | Safe vent before failure connected to expansion chamber. |
| 309 | Leak detect and alarm, ultrasonic preferred. |
| 310 | Swing arm dispensing tube. |
| 311 | CNG specific fill start/stop/auto stop. |
| 312 | CNG specific fill attachment. |
| 313 | Vent and stand pipe connected to expansion chamber. |
| 314 | Heat sink to air in heat transfer for the benefit of vaporization LNG. May be a |
| | water bath, may be as cooling fins, or refrigeration coil. |
| 315 | Vertical and lateral support. |
| 316 | Heat exchange for heat sink such as available from exhaust stack or direct heat. |
| 317 | Optional hydrogen input to enhance CNG quality as available from electrolysis |
| | at depth or other. |
| 318 | Optional supply NG from inner container. |
| 319 | Control and instrument panel LNG to CNG system. |
| 320 | Internal LNG drip pipe. |
| 321 | Pressure reducing valve for (318) and (322). |
| 322 | Optional supply NG from expansion chamber. |
| 323 | Chemical additives to natural gas to be used for residential fuels often use a |
| | sulfur compound (enhancing leak detection). |

### DETAILED DESCRIPTION OF THE PREFERRED EMBODIMENTS

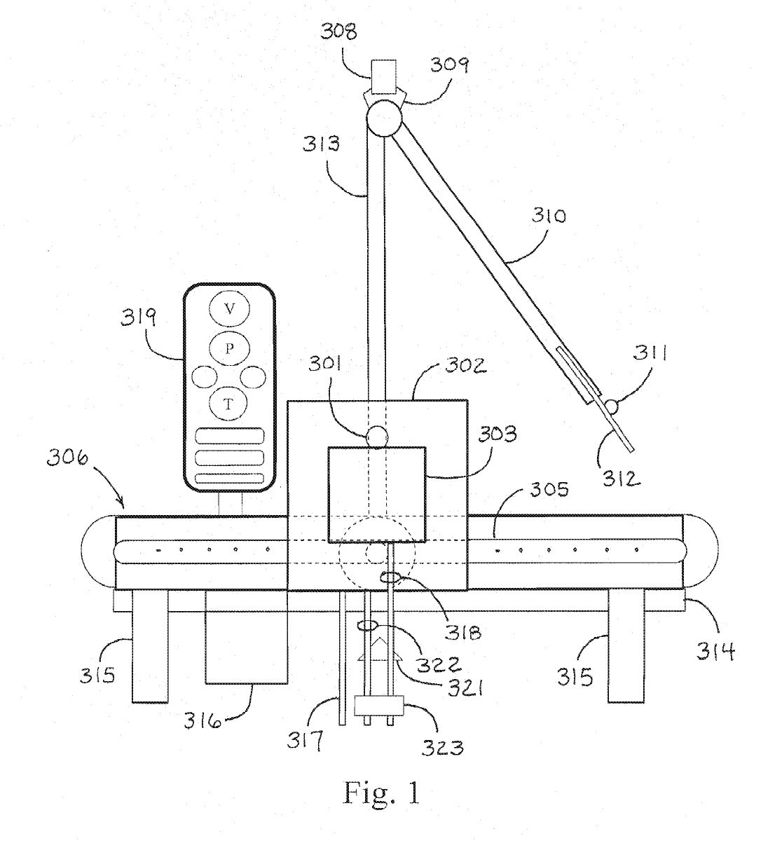

The present invention provides an LNG to CNG to NG system and method. This system may be optionally enhanced by a system generating hydrogen gas such as an electrolysis at pressure and/or at depth system. The system may also be optionally enhanced by a steam and methane reformation system, including as a heat exchange mechanism described. In the system of FIGS. 1 & 2, an oval CNG expansion chamber 2.4 times the size of the LNG cryogenic container is provided with center tube circles vented. High nickel alloy steel and some aluminum alloys are preferably used in the construction of this system where there is contact with cryogenic liquids. The system further includes passive and active heat sinks The system includes LNG fill portal 301 for the cryogenic like vessel. Also disclosed are outer container 302 and inner container 303 for the LNG. Again, the approximate ratio of the container volume being 1:2.4 to the volume of oval pressure vessel expansion chamber 306.

Neck pipe 304 provides a one way flow with valve that connects the LNG container to the CNG expansion chamber inner pipe Inner oval pipe 305 has a volume in the approximate ratio of 1:1 with inner container 303. Oval pressure vessel expansion chamber 306 is preferably made of duplex stainless steel. Transfer holes 307 are provided to vent vaporizing LNG into oval pressure vessel expansion chamber 306 in a uniform manner. A safe vent valve 308 is provided before oval pressure vessel expansion chamber 306. A leak detection and alarm device 309 is also provided, with an ultrasonic type device preferred.

Swing arm dispensing tube 310 extends to provide the manner of dispensing the CNG. A CNG specific fill valve 311 provides start, stop, and auto stop for the flow. A CNG specific fill attachment 312 is also provided. Vent and stand pipe 313 is connected to oval pressure vessel expansion chamber 306. Heat sink 314 to air is provided for heat transfer for the vaporization of the LNG. Vertical and lateral supports 315 are shown for the structural support of the system. Heat exchange 316 is shown such as is available from the exhaust stack in the steam and NG reformation system described above. Hydrogen input 317 is further provided to enhance CNG quality and is available from an electrolysis at depth system mentioned above, or an electrolysis at pressure system. Optional natural gas (NG) supply 318 is provided to enhance CNG quality as is also available from a steam and NG reformation system as mentioned above. Control and instrument panel 319 is provided to monitor CNG volume, pressure, and temperature in the system, as well as to show time, elapsed time, and to indicate a percentage to add hydrogen.

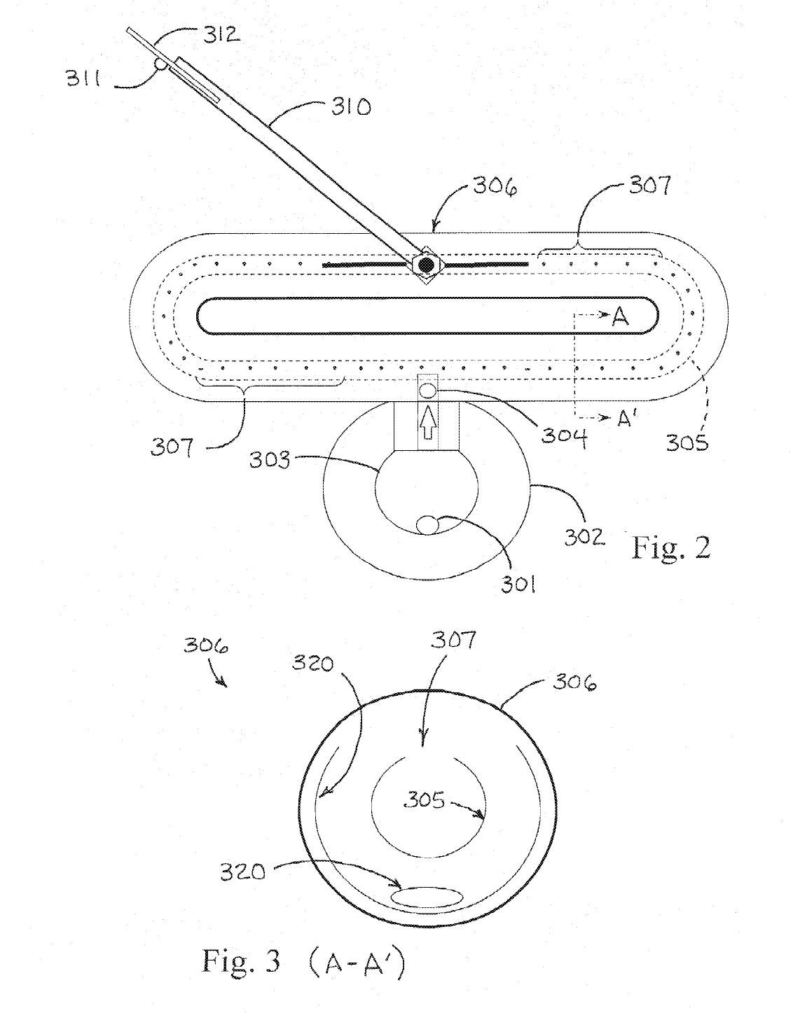

Reference is made to FIG. 3 which is a cross-section view of taken along section line A-A′ in FIG. 2. Oval pressure vessel expansion chamber 306 is shown surrounding inner oval pipe 305. Below and within expansion chamber 306 is internal LNG drip pipe 320. Collectively, FIGS. 1-3 demonstrate the method of the present invention by reference to the details of the system designed to carry out the method at ambient parameters.

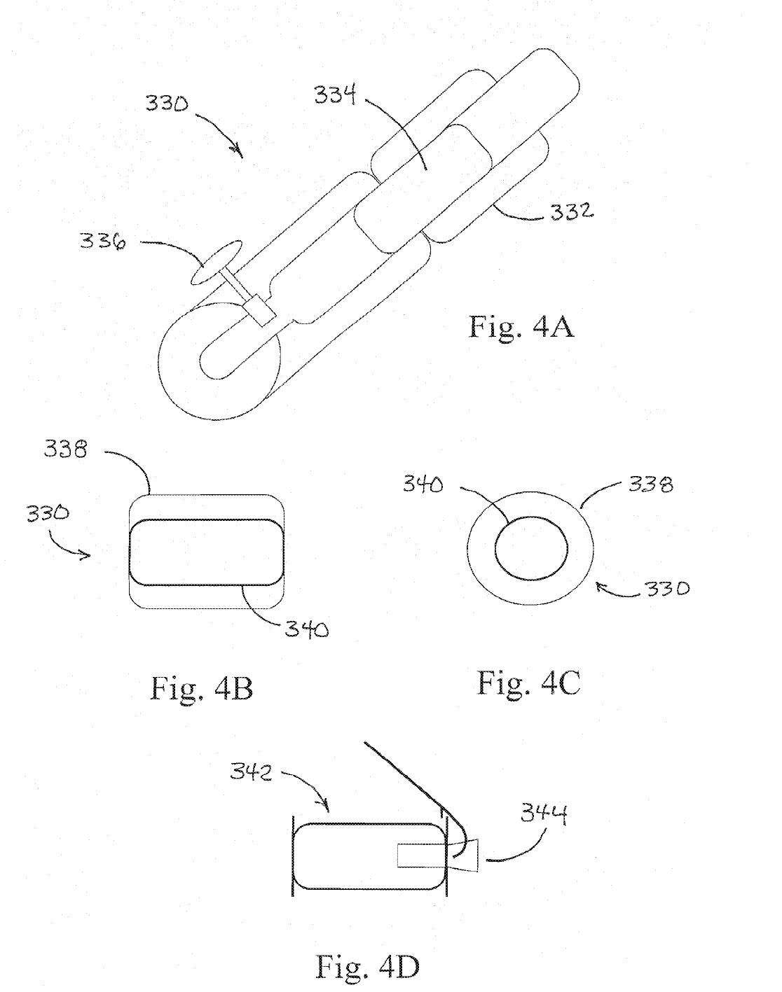

FIGS. 4A-4D provide detailed views of an LNG personal supply tank component of the system of the present invention. Portable LNG tanks without wheels (less than 7 gallons liquid or weighing about 50 lbs.) and portable LNG tanks with wheels (carrying about 25 gallons) may become an integral part of delivery, fueling the phase change and adjusting system of the present LNG to CNG to NG system. This personal LNG tank 330 would preferably be a high pressure bottle 334 (or 340 or 342) surrounded by insulation 332 (or 338). Appropriate valves 336 and fill/dispense attachments 344 would be utilized. Such an element may be a standalone liquid container for other LNG devices as well.

The feasible elements do exist for this new component of the system. These may be characterized as liquid individual natural gas (LiNG) devices and pressurized liquid individual natural gas (PLiNG) devices. This accessory would be a cryogenic container with an LNG specific input port and output port. It would be constructed with at least one container within a container and further nesting of containers possible. It would preferably be structured with layers of insulation, vacuum layers, and layers of reinforcement. The container would preferably be engineered at a 2:1 length to width ratio and comprise nickel at 7%-9% where there is contact with liquid. The container may hold a cold thermal mass to deter gasification. It should be able to be emptied without tipping using a hand pump. The system of the present invention would use such a container as a “stage” to ramp down temperatures of the equipment in order to mitigate issues of thermal shock to the system. The container could also be used as a method of topping off the system of the present invention.

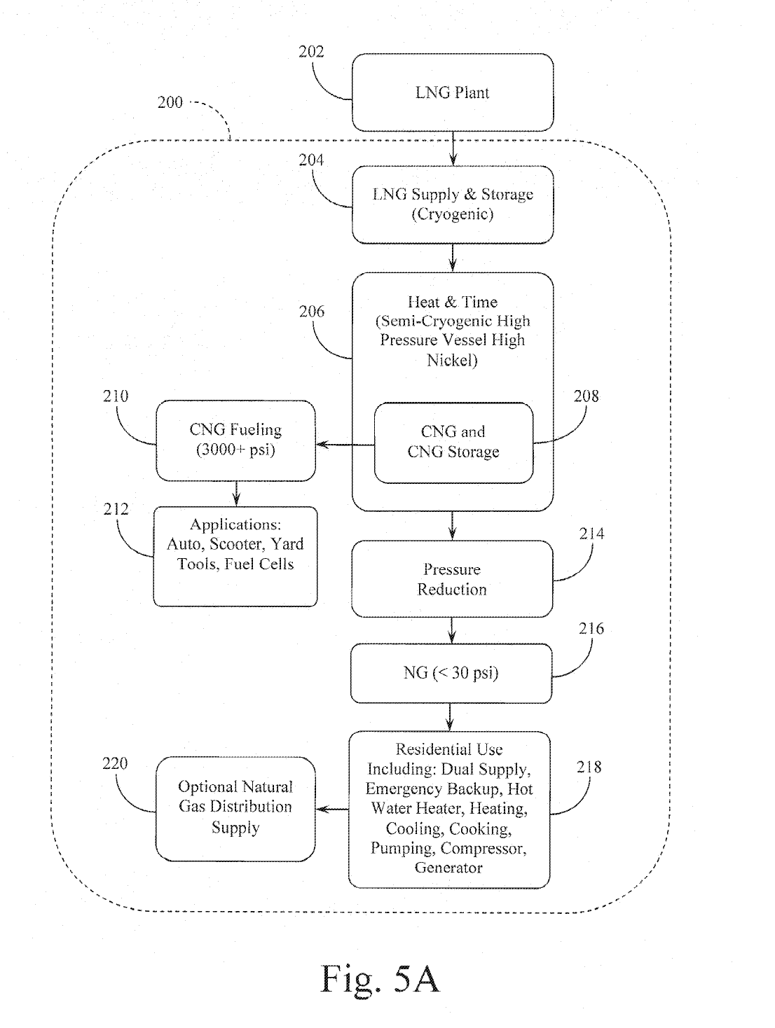

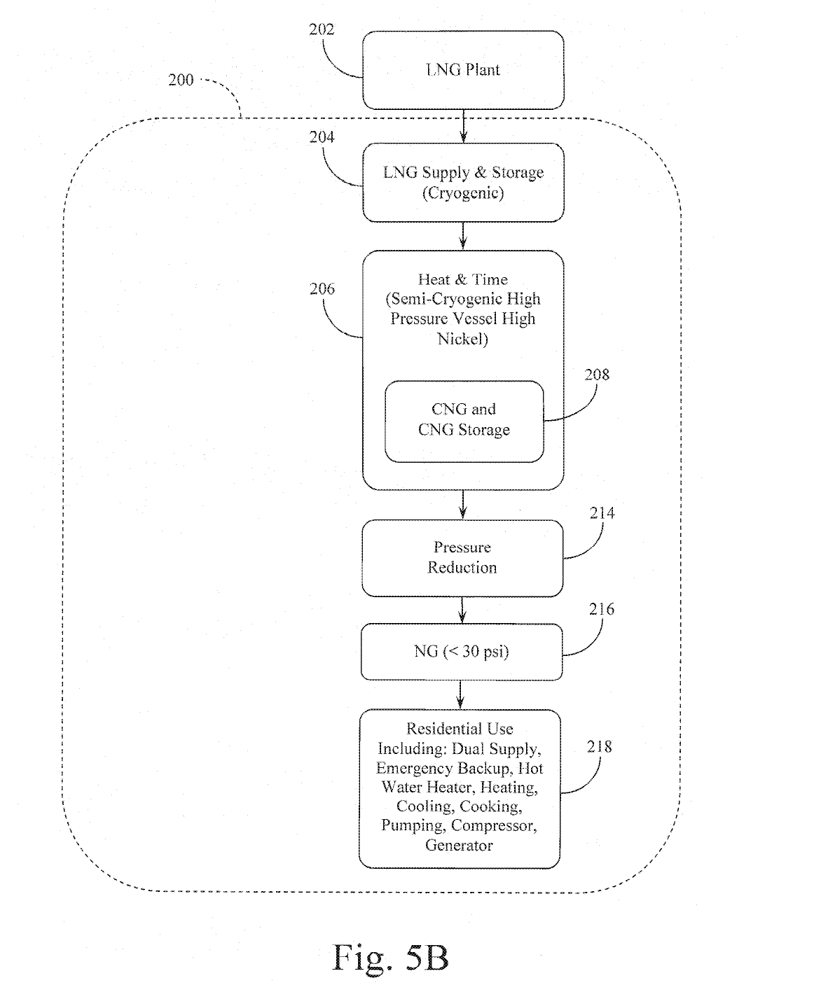

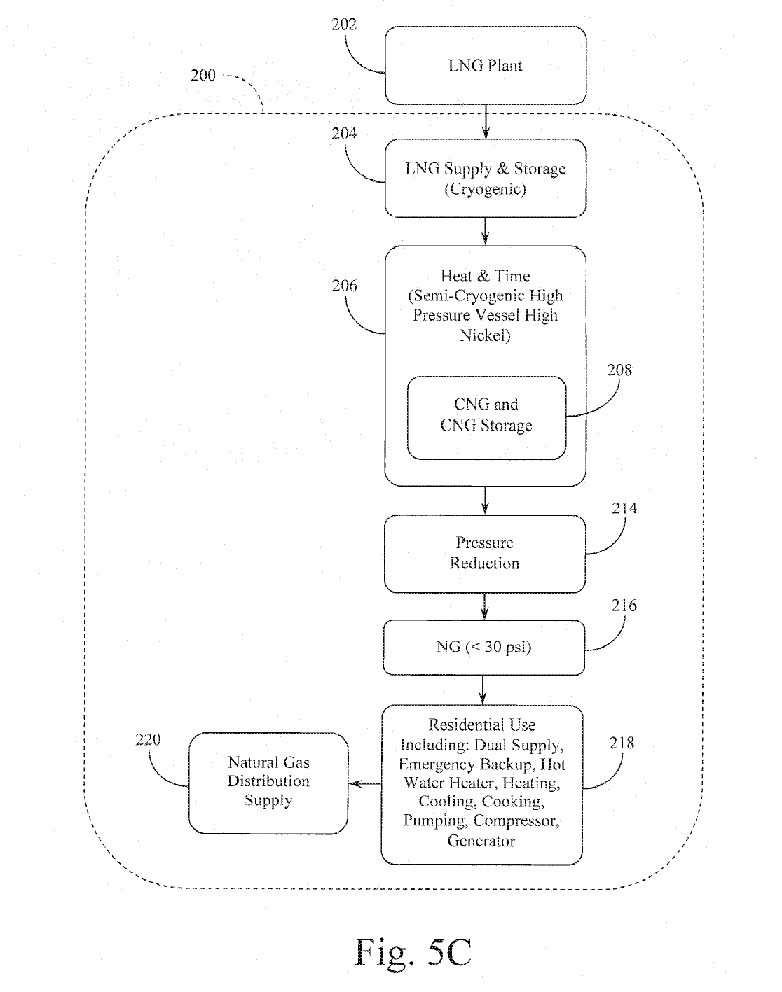

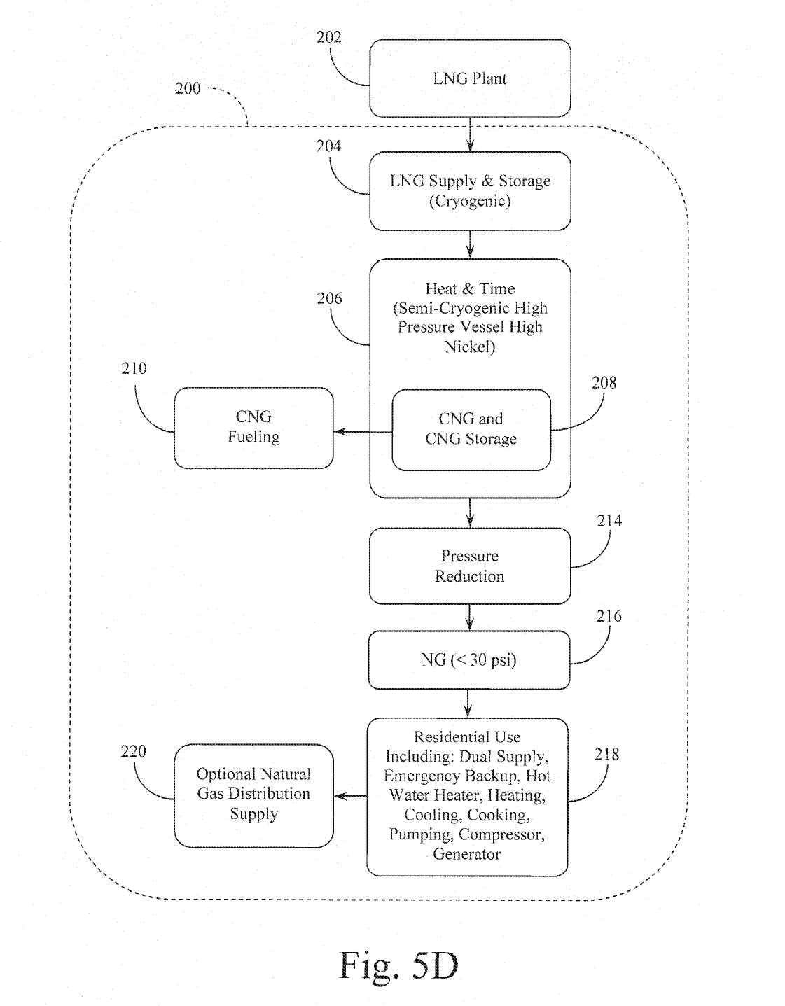

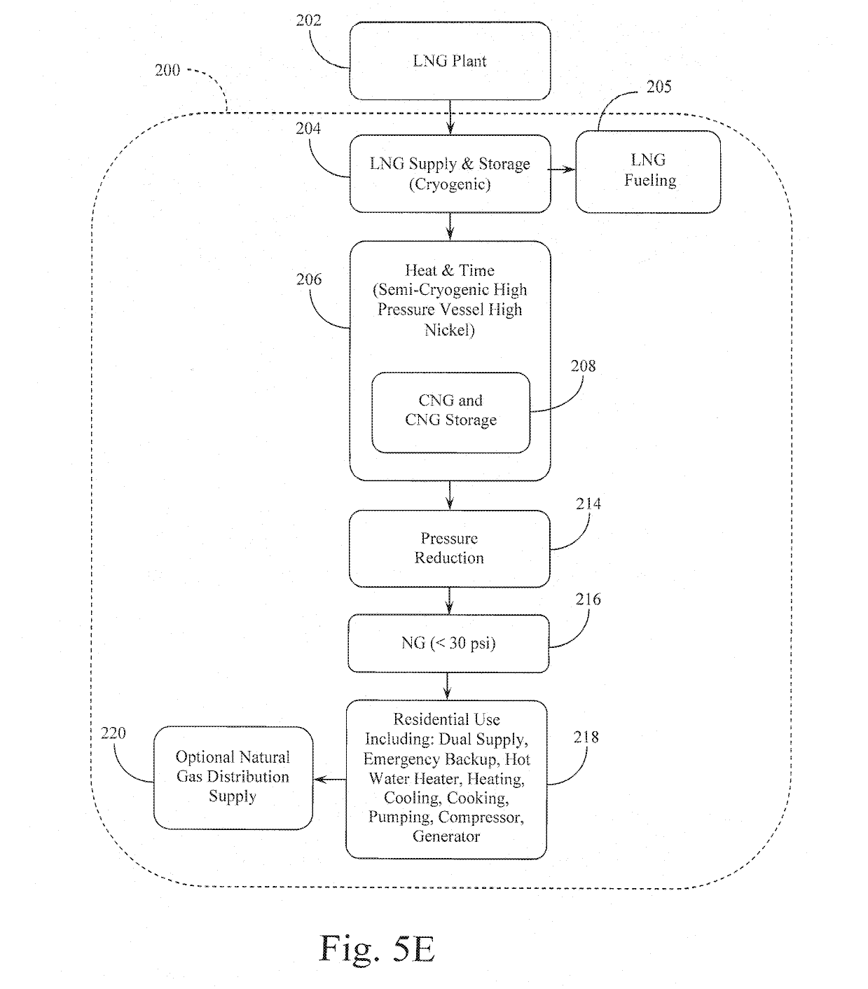

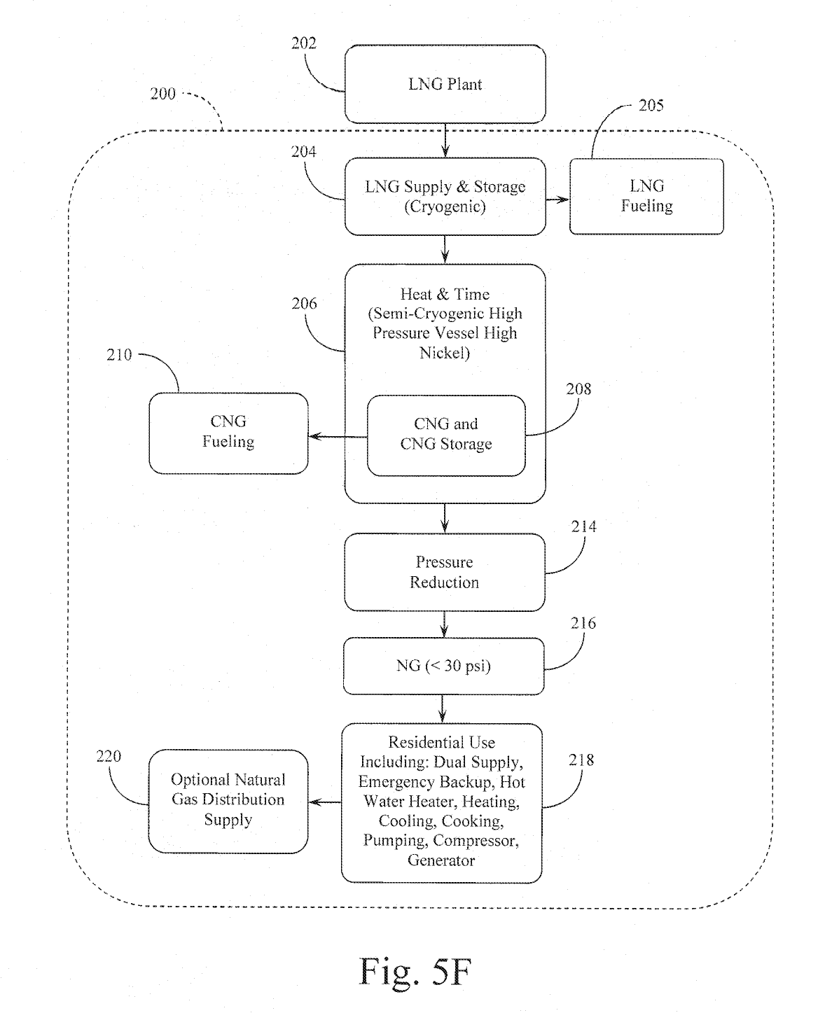

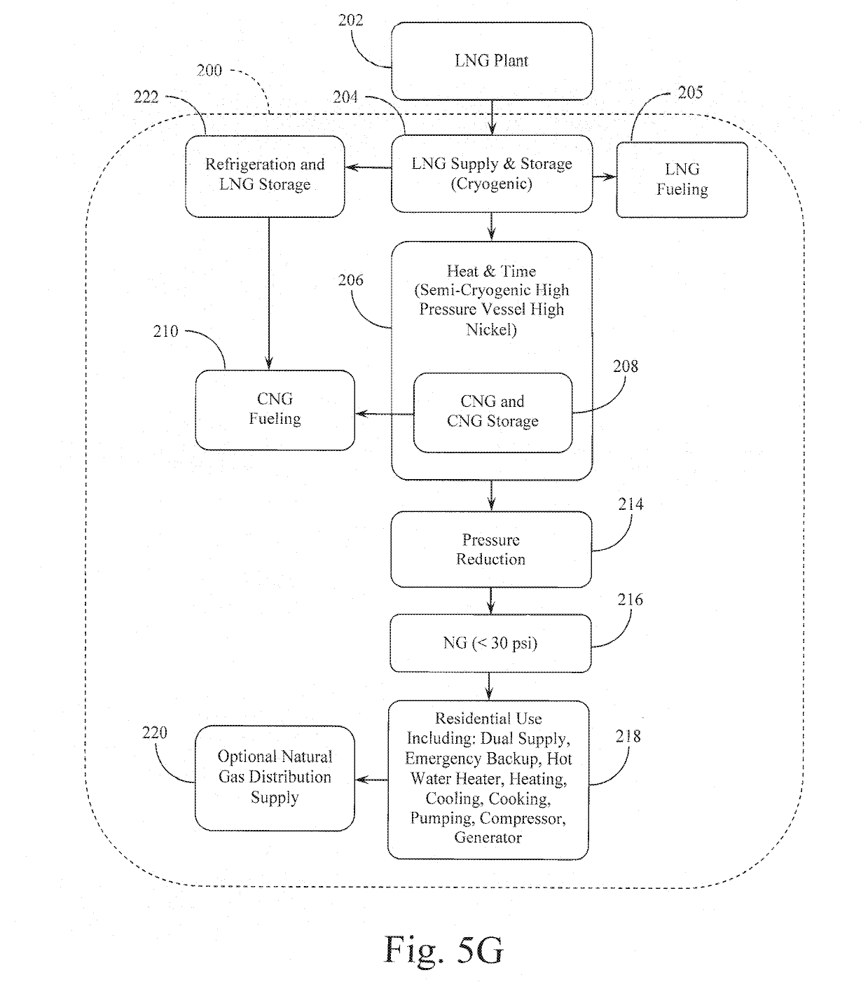

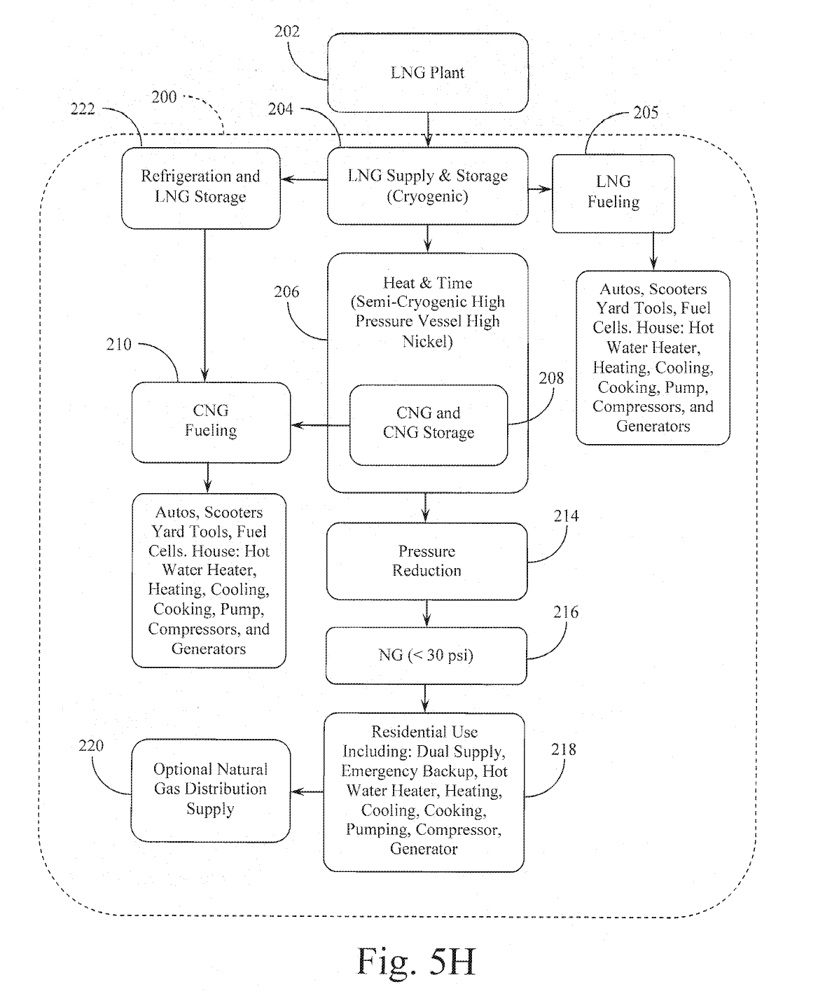

Reference is next made to FIGS. 5A-5H which are schematic block diagrams showing a variety of applications of the LNG to CNG to NG system and methods of the present invention. In these diagrams residential area 200 is shown to implements the systems of the present invention receiving an LNG supply from LNG plant 202. Internal to the area is LNG supply and cryogenic storage 204. Through heat and time in the system of the present invention 206, and from CNG storage 208, the CNG may be utilized in CNG fueling 210 to applications 212. Through pressure reduction 214 the system produces NG (<30 psi) 216 for residential use 218 and optional natural gas distribution 220.

FIG. 5A shows the preferred embodiment system and method. FIG. 5B the preferred residential use embodiment. FIG. 5C the addition of access to the NG distribution system. FIG. 5D the addition of the CNG fueling option. FIG. 5E the addition of the LNG fueling option 205. FIG. 5F the addition of both the CNG and LNG fueling options. FIG. 5G adds the use of a refrigeration and LNG storage component 222. Finally, FIG. 5H incorporates all of the above mentioned options.

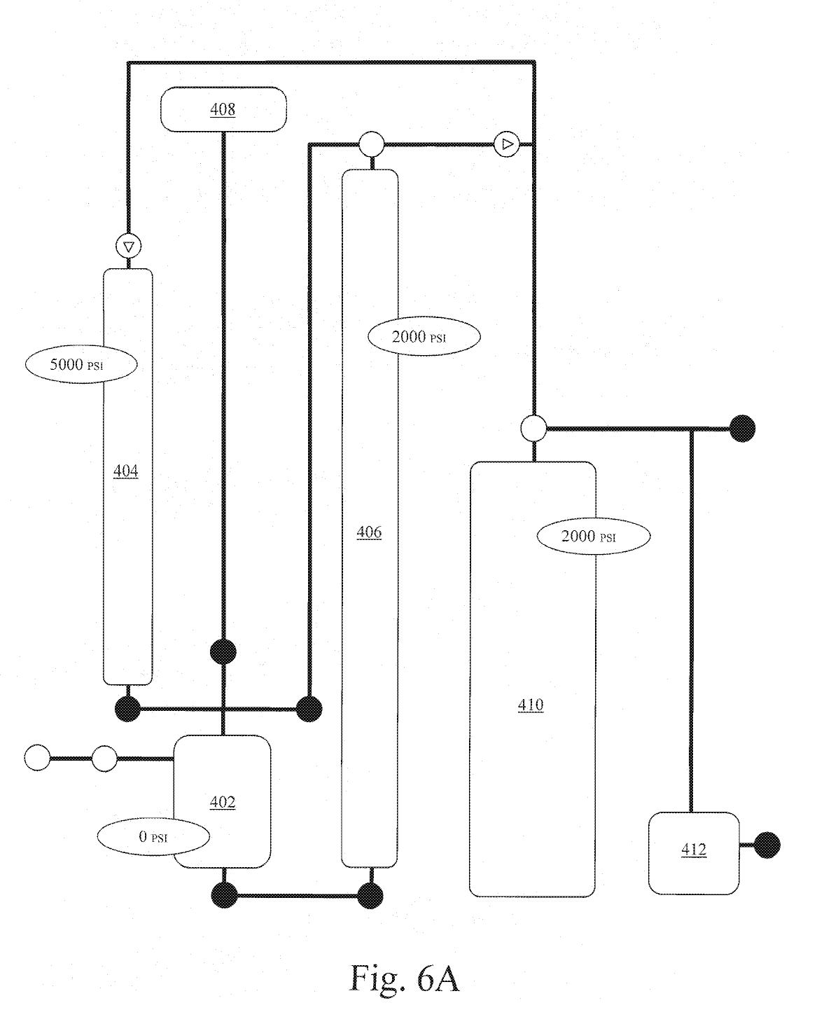

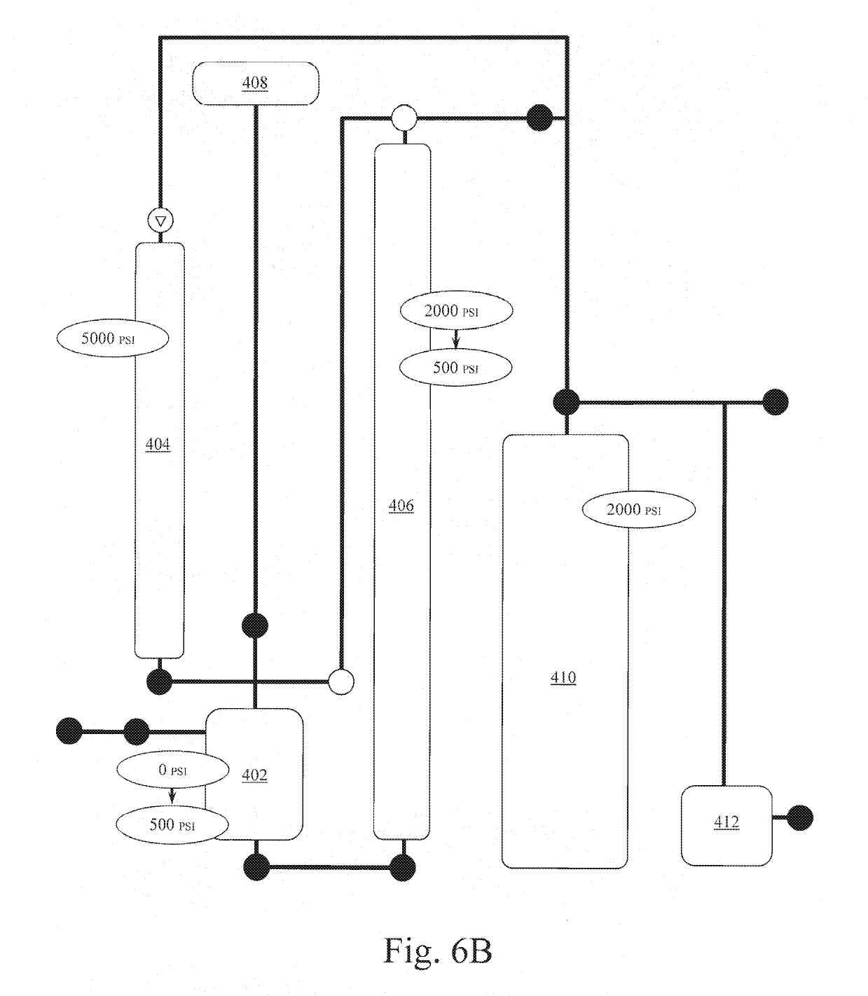

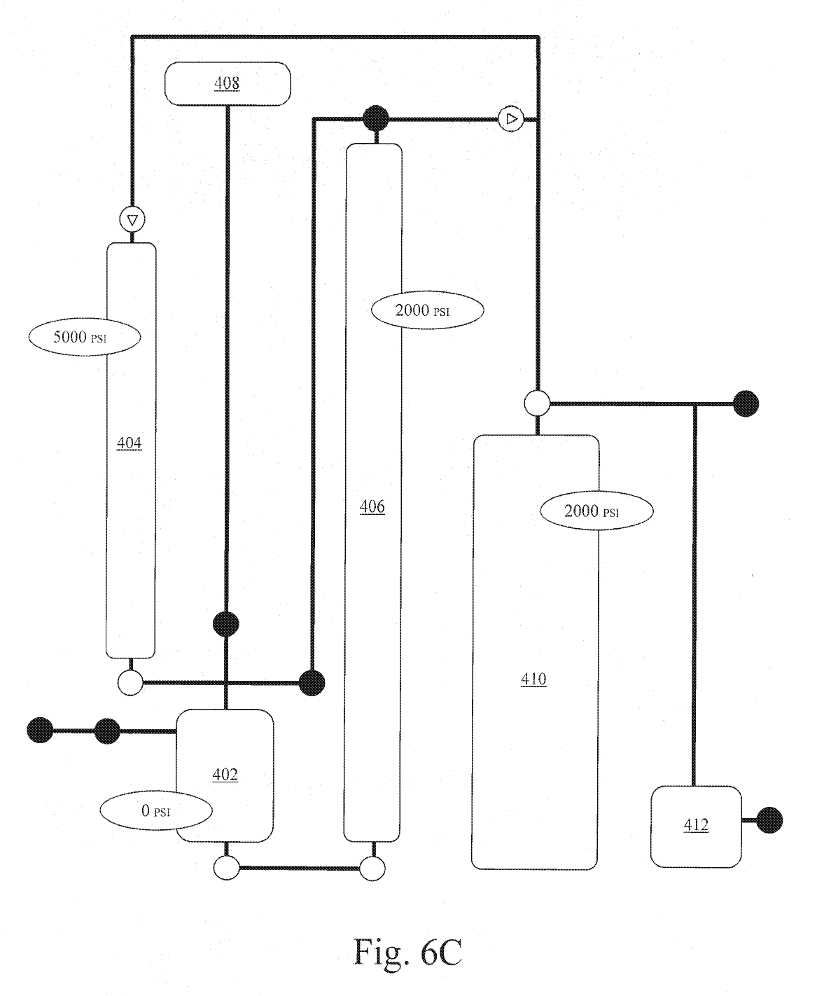

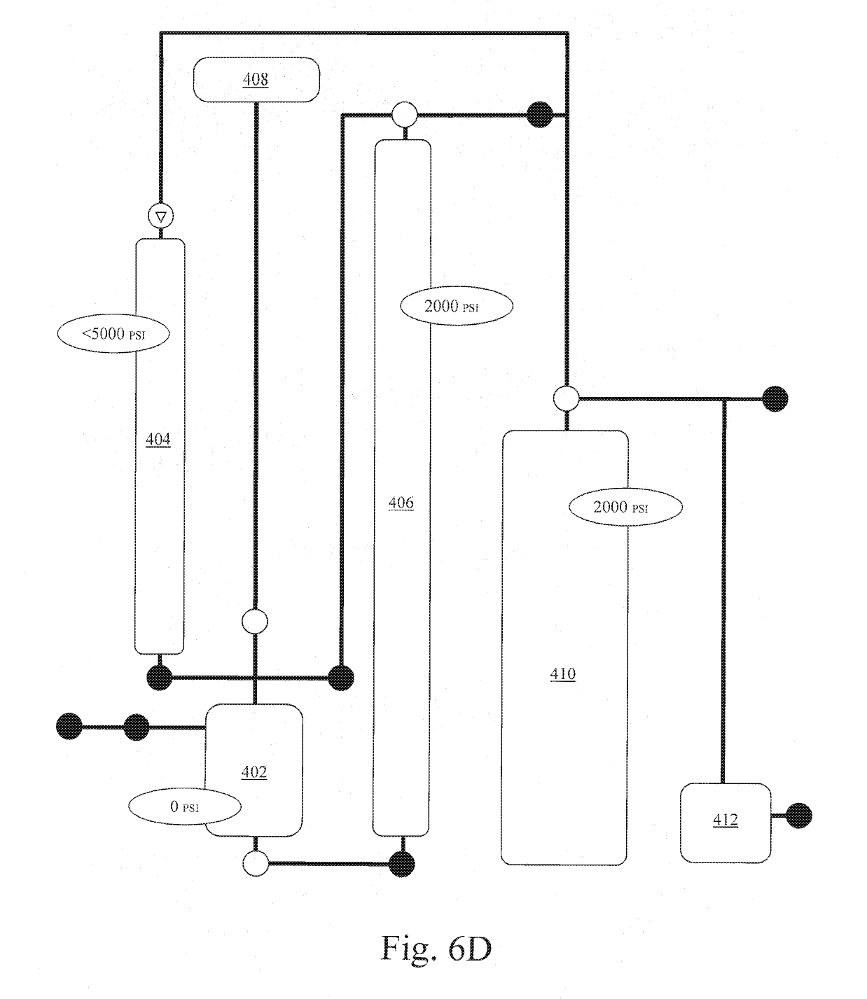

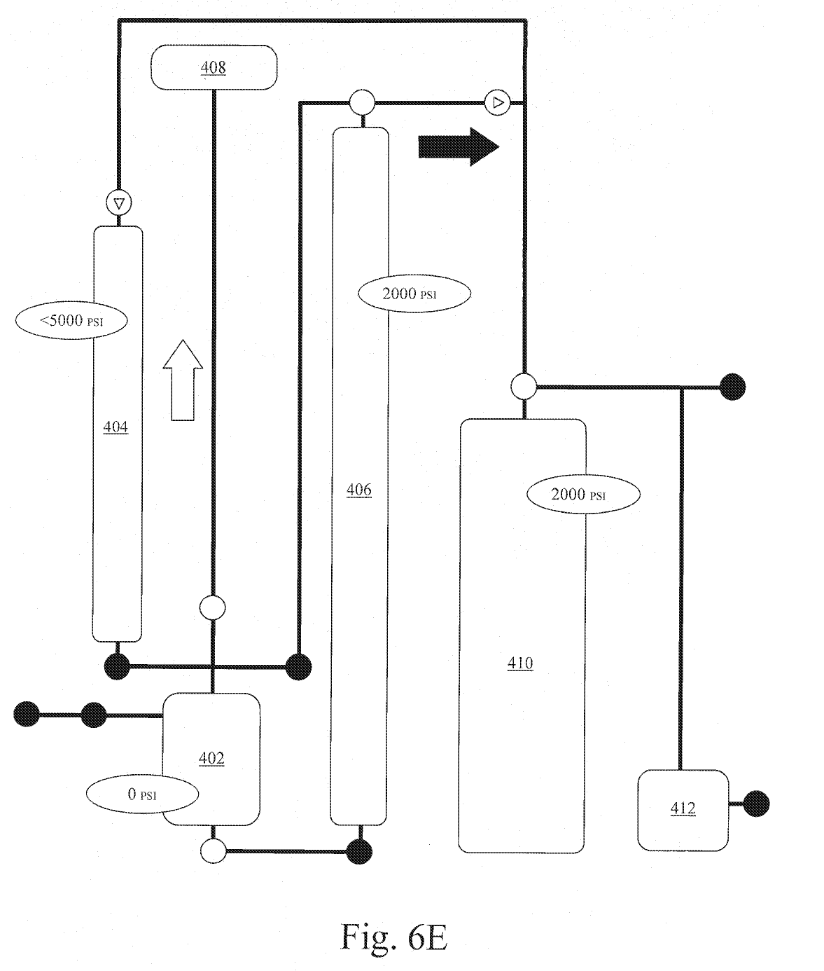

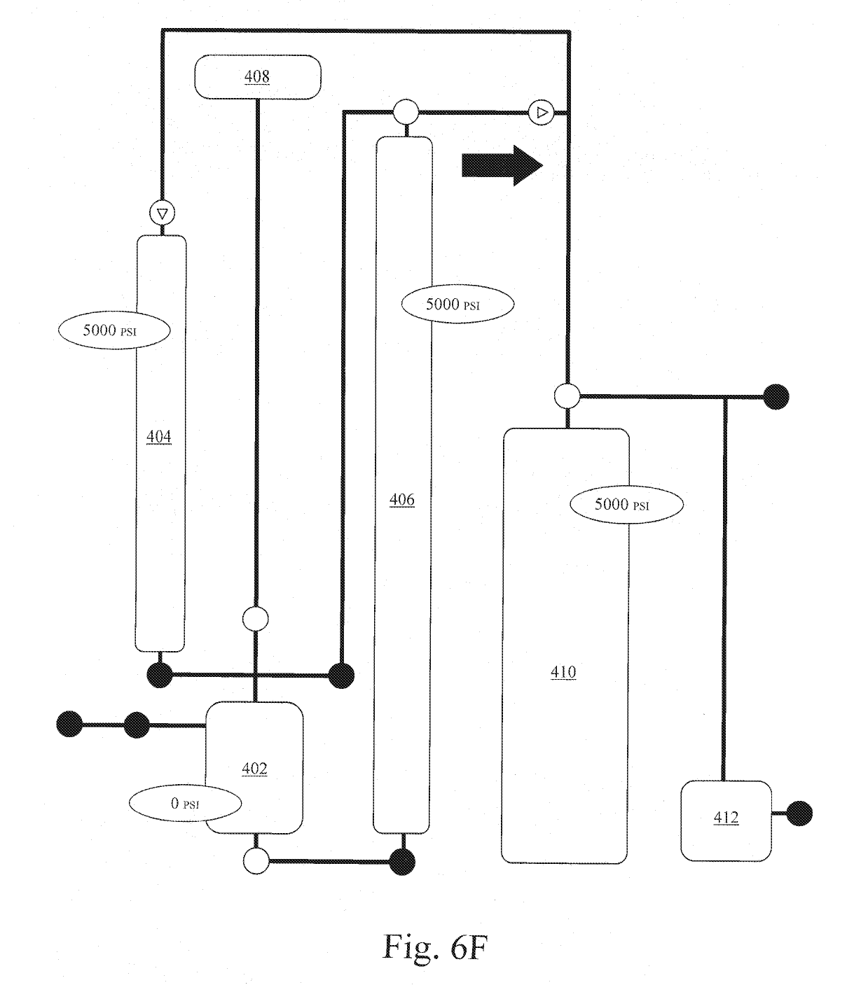

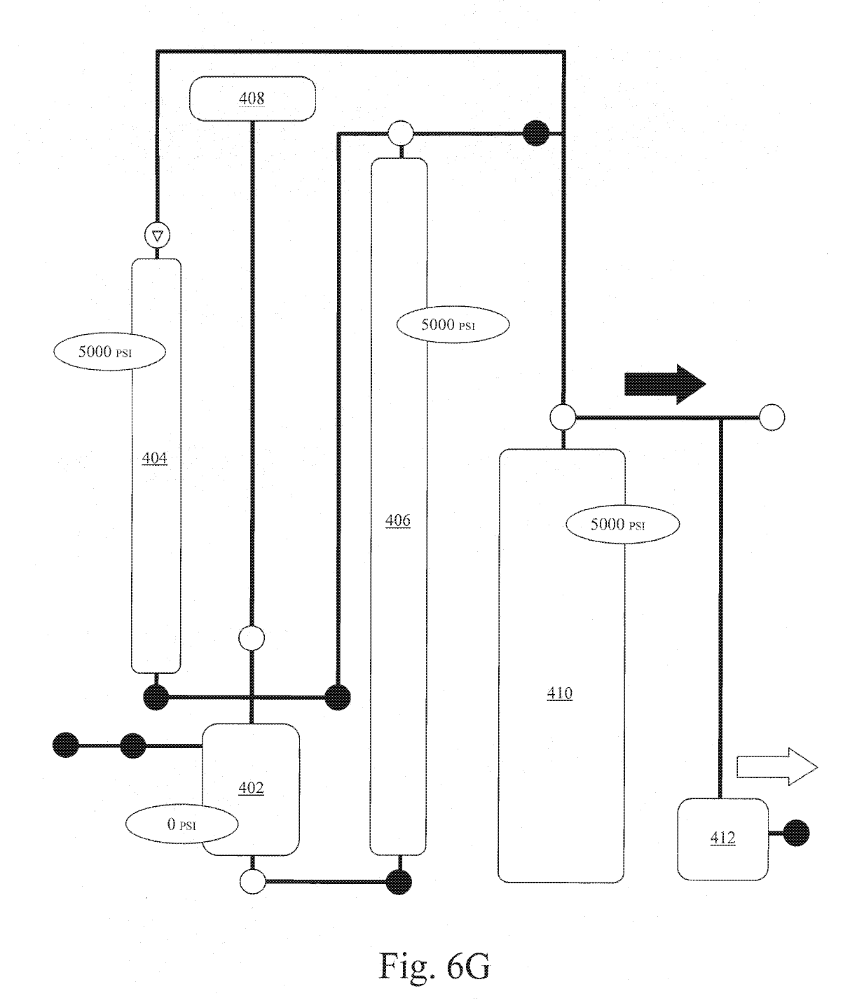

Reference is next made to FIGS. 6A-6G which show an alternate preferred embodiment of the structure of a system implementing the method of the present invention. This series of drawing figures discloses in partially schematic form (relative sizes represented) the basic structure of the system of the present invention and the progress of the method implemented with the system for converting LNG to usable CNG.

FIG. 6A discloses the essential components in the system and identifies operation of the system through a first step of loading LNG. In general, the system 400 comprises LNG container 402, CNG maximum pressure container 404, LNG-CNG phase change container 406, NG powered heater 408, CNG storage container 410, and pressure reducer 412.

In the first step of the process where LNG is loaded into the system, valves leading into LGN container 402 are opened to receive the LNG. In FIG. 6A open valves are represented as open circles, with closed valves represented as darkened circles. One way valves and check valves are represented with triangles in circles. The CNG maximum pressure container 404 is at 5,000 psi while the LNG-CNG phase change container 406 is at 2,000 psi. Likewise, CNG storage container 410 may preferably be at 2,000 psi. FIG. 6B represents a balancing of pressure step in the operation of the system. Inlet valves are closed and valves between LNG container 402 and LNG-CNG phase change container 406 are opened. Thus beginning at 0 psi in LNG container 402 and ending at 500 psi. LNG-CNG phase change container 406 begins at 2,000 psi and ends at 500 psi.

In FIG. 6C the step of charging phase change container 406 with LNG is carried out. In this view, the LNG is contained in a center Dewars like container within LNG-CNG phase change container 406. A valve is opened between LNG container 402 and CNG maximum pressure container 404. CNG maximum pressure container 404 begins at 5,000 psi and ends at less than whatever pressure is required to move the LNG into the phase change container 406. CNG storage container 410 remains at 2,000 psi.

FIG. 6D demonstrates the step of applying heat to the phase change container 406 to facilitate the overall process. In this view, NG powered heater 408 is auto ignited at gas detection and heats a coil positioned along the length of phase change container 406. CNG maximum pressure container 404 is now below 5,000 psi, once again representing only the pressure required to move the LNG into the phase change container 406. LNG container 402 varies in pressure until all of the NG is consumed in the process resulting in a 0 psi in LNG container 402. CNG storage container 410 again operates at 2,000 psi.

FIG. 6E represents the step of joining the LNG-CNG phase change container 406 and the CNG storage container 410. Each of these two containers are then optimally positioned at 2,000 psi. The valves indicated between the CNG containers are activated when the pressures are equal.

Reference is next made to FIG. 6F which shows the step of gasification being completed. Once again, NG powered heater 408 is operable to facilitate the movement of LNG into the phase change container 4306 and thereby into the CNG storage container 410. Given the volumes and pressures associated with the previous steps in the system, the balance pressure between LNG-CNG phase change container 406 and CNG storage container 410 should end up at approximately 5,000 psi. This is also the pressure in CNG maximum pressure container 404. The process, facilitated by NG powered heater 408, utilizes all of the LNG deposited into LNG container 402.

Finally, as shown in FIG. 6G, dispensing of the CNG may occur. Once again, the LNG container 402 is at 0 psi having expended all of its volume either into powering the NG powered heater 408 or primarily in converting LNG to CNG through phase change container 406 into CNG storage container 410. As shown in FIG. 6G, CNG may be dispensed directly from CNG storage container 410 or may be dispensed through an optional pressure reducer 412 to dispense low pressure natural gas. Typical pressures for the low pressure natural gas may be less than two atmospheres. The dispensing process is a two stage process. As shown, the CNG storage container 410 would dispense until pressure equalizes the tank being filled. At that point, the isolating valve between the phase change container 406 will open and the tank pressure is topped off.

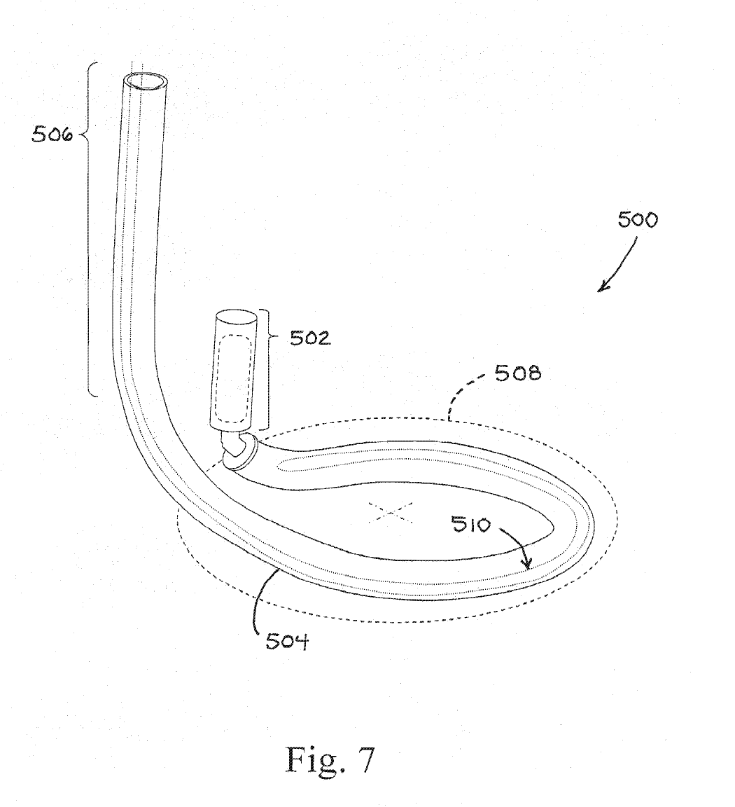

FIG. 7 a perspective view of a preferred embodiment of the phase change container structure of the present invention showing one implementation of a number of the structures shown generally in FIGS. 6A-6G. The critical features disclosed in FIG. 7 the horizontal and vertical elements that make up the arrangement of the LNG container 502 and the LNG-CNG phase change container 504. The arrangement show allows for the gravity feed of LNG from LNG container 502 (a Dewar container oriented vertically) into phase change container 504 (a partial Dewar container oriented horizontally). Phase change container 504 is preferably constructed of a single section of tubular wall for ease of manufacture and maintenance. Heating element 510 extends into phase change container 504 as, for example, deriving from NG powered heater 408 shown in FIGS. 6A-6G.

Operation of the structure of the system shown in FIG. 7 is essentially the same as that shown in FIGS. 6A-6G with the same set of valves and flow conduits. The gravity feed structure of the embodiment shown in FIG. 7 eliminates the need to have CNG maximum pressure container 404 to push the LNG into the LNG-CNG phase change container as this is now accomplished by gravity feed. Here again, the system lends itself to implementation in smaller (lower quantities) environments such as residential homes, small industrial applications, and the like.

Although the present invention has been described in conjunction with a number of preferred embodiments, those skilled in the art will recognize modifications to these embodiments that still fall within the scope of the present invention. Alternately, the present invention may be implemented in conjunction with electrolysis at depth and/or pressure. Alternate embodiments in conjunction with differently sized systems are also anticipated.

I claim:

1. A portable LNG supply system comprising:
a. at least one empty LNG receiving tank, the receiving tank also serving as a gasifier and a pressure gas container and accepting gravity flow of liquids;
i. the LNG receiving tank in selective communication with a safely isolated natural gas heater;
ii. the LNG receiving tank in selective communication with the head of a phase change gasifier; and
iii the LNG receiving tank with the most liquid communicated bottom in selective communication with an internal container within the phase change gasifier;
b. a natural gas heater in communication with a system to enhance thermal transfer to the LNG receiving tank;
c. at least one phase change gasifier, comprising:
i. components to isolate cryogenic liquids from exterior contact; and
ii. components to receive gravity flow of liquids; and
d. sensors, instrumentation, control, and insulation components to facilitate operation of the system.

2. The system of claim 1, where the primary containment of the phase change gasifier comprises a round hoop base with an upright pipe member and the horizontally oriented hoop base in the process is the location of the cryogenic liquids in the process of gasifying and the vertical standing pipe is the location of the produced compressed gas.
